(19) United States
(12) Patent Application Publication
(10) Pub. No.: US 2009/0086720 A1
(43) Pub. Date: Apr. 2, 2009

(54) IDENTITY ASSOCIATION WITHIN A COMMUNICATION SYSTEM

(75) Inventor: Scott Grier Westlake, San Jose, CA (US)

Correspondence Address: AMIN, TUROCY & CALVIN, LLP, 127 Public Square, 57th Floor, Key Tower, CLEVELAND, OH, 44114, US

(73) Assignee: CISCO TECHNOLOGY, INC., San Jose, CA (US)

(21) Appl. No.: 12/033,498

(22) Filed: Feb. 19, 2008

Related U.S. Application Data
(60) Provisional application No. 60/976,217, filed on Sep. 28, 2007.

(51) Int. Cl. H04L 12/66

(52) U.S. Cl. 370/352

(57) ABSTRACT

A system is disclosed that combines social network linkage information with a caller's phone number or identity. This linkage enables communication systems, such as Voice-over-Internet Protocol (VoIP) phone systems, to provide rich caller-ID information. The system can also combine other contextual and mobility-based information to provide rich information to a user with respect to incoming (or outgoing) communications.

### CROSS-REFERENCE TO RELATED APPLICATIONS

This application claims the benefit of U.S. Provisional Patent application Ser. No. 60/976,217 entitled “IDENTITY ASSOCIATION WITHIN A COMMUNICATION SYSTEM” and filed Sep. 28, 2007. The entirety of the above-noted application is incorporated by reference herein.

### BACKGROUND

The Internet has spawned many communication mediums that continue to become increasingly popular and wide spread. The ever-growing popularity of internet-capable devices has contributed to this continued popularity. These communication mediums include but are not limited to electronic mail (email), Voice-over-Internet protocol (VoIP), instant messaging (IM) and text messaging over a network of two or more computers or network connectable, processor-based devices.

VoIP, aka broadband telephony, refers to a protocol of routing voice conversations via the Internet or any other IP-based network. While VoIP is technologically advanced in view of conventional telephony systems, it retains some of pitfalls of the traditional systems. For example, spam or unsolicited communications continue to plague these systems. As well, although technologically advanced, VoIP systems, and particularly VoIP caller-ID (identification) lacks personalization.

Companies that provide VoIP service are commonly referred to as providers, and protocols which are used to carry voice signals over the IP network are commonly referred to as ‘Voice-over-IP’ or ‘VoIP’ protocols. Some cost savings of the VoIP protocol can be attributed to a single network to carry voice and data, especially where users have existing underutilized network capacity that can carry VoIP at no additional cost. Popularity of the use of VoIP communication mechanisms is on the rise as VoIP phone calls are often free to both parties, while VoIP to conventional public switched telephone networks (PSTN), may have a cost which is often charged to the VoIP user in these scenarios.

VoIP can facilitate tasks that may be more difficult to achieve using traditional networks. For example, an ability to transmit more than one telephone call via a single broadband-connected telephone line is achievable with today's VoIP protocol. One benefit of this feature is that it easily enables addition of an extra telephone line to a home or office. Moreover, incoming phone calls can be automatically routed to a VoIP phone, regardless of the location of the network connection. Thus, a user can employ a VoIP phone to make and receive calls anywhere the Internet is available.

Consistent with traditional PSTN and cellular-based systems, VoIP features most often include features such as 3-way calling, call forwarding, auto-redial, caller-ID as well as voice-mail. However, unlike these traditional systems, these features are most often included free of charge with the base connection. Additionally, VoIP phones can integrate with other services available over the Internet, such as video conferencing, message and data file exchange in parallel with the conversation, audio conferencing, PIM (personal information manager) data management, etc.

Although VoIP systems are technologically advanced as related to conventional telephony systems, to date, features have been generally limited to the features of traditional systems. For example, caller-ID, in its simplest form mimics the functions of a traditional telephony system. In other words, today's VoIP systems do not leverage the power of the computer and network in offering caller-ID features.

### BRIEF DESCRIPTION OF THE DRAWINGS

FIG. 1 illustrates an example system that leverages private, social network and public data to comprehensively manage incoming communications.

FIG. 2 illustrates an example flow diagram of procedures that facilitate personalized identity information generation and display in accordance with an aspect of the specification.

FIG. 3 illustrates an example flow diagram of procedures that facilitate message management in accordance with established personalized information.

FIG. 4 illustrates an example system that facilitates generation and rendering of personalized identity information in accordance with an aspect of the specification.

FIG. 5 illustrates an example identity determination component that establishes identity information from an incoming communication.

FIG. 6 illustrates an example analysis component that establishes communication-specific criteria in accordance with aspects of the specification.

FIG. 7 illustrates an example identity association component that establishes connections and relationships based upon the communication-specific criteria.

FIG. 8 illustrates an example communication management component that facilitates manual or automatic communication management in accordance with an aspect of the innovation.

FIG. 9 illustrates a block diagram of a computer operable to execute the disclosed architecture.

FIG. 10 illustrates a schematic block diagram of an example computing environment in accordance with the subject specification.

### DETAILED DESCRIPTION

### Overview

The following presents a simplified overview of the specification in order to provide a basic understanding of some aspects of the specification. This overview is not an extensive overview of the specification. It is not intended to identify key/critical elements of the specification or to delineate the scope of the specification. Its sole purpose is to present some concepts of the specification in a simplified form as a prelude to the more detailed description that is presented later.

The specification disclosed and claimed herein, in one aspect thereof, comprises a communication system that employs an identity management component that incorporates private data, social network (SN) data, and public data into management of communications. For example, the identity of a caller can be used to establish relationships to a callee—the relationship information can be provided to the callee in order to afford the callee an opportunity to accept or otherwise handle the communication. Additionally, embodiments employ predetermined rules and/or inferences to automatically manage the communication as a function of identity and relationship information.

In other particular aspects, the specification describes a system that comprises a Voice-over-Internet Protocol (VoIP) system that is capable of combining functionality of a caller-ID system together with information provided by an SN service (e.g., LinkedIn™) as well as other private and public data. More particularly, the specification can provide comprehensive information about a caller such as, but not limited to, common relationships between the caller and callee, association of the caller to the callee, etc. This information can be established by way of pre-existing third-party SN services or other relationship data.

In another aspect of the subject specification, the system can be employed to combine contextual factors such as mobility to provide useful and comprehensive information about a caller. In still other aspects, the features, functions and/or benefits of the specification can be employed in accordance with other network-based communication modalities, including but not limited to, email, text messaging, instant messaging, picture messaging or the like.

In yet another aspect thereof, machine learning and reasoning mechanisms are provided that employ a probabilistic and/or statistical-based analysis to prognose or infer an action that a user desires to be automatically performed.

To the accomplishment of the foregoing and related ends, certain illustrative aspects of the specification are described herein in connection with the following description and the annexed drawings. These aspects are indicative, however, of but a few of the various ways in which the principles of the specification can be employed and the subject specification is intended to include all such aspects and their equivalents. Other advantages and novel features of the specification will become apparent from the following detailed description of the specification when considered in conjunction with the drawings.

### DETAILED DESCRIPTION OF EXAMPLE EMBODIMENTS

The specification is now described with reference to the drawings, wherein like reference numerals are used to refer to like elements throughout. In the following description, for purposes of explanation, numerous specific details are set forth in order to provide a thorough understanding of the subject specification. It may be evident, however, that the specification can be practiced without these specific details. In other instances, well-known structures and devices are shown in block diagram form in order to facilitate describing the specification.

As used in this application, the terms ‘component’ and ‘system’ are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to ‘infer’ or ‘inference’ refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

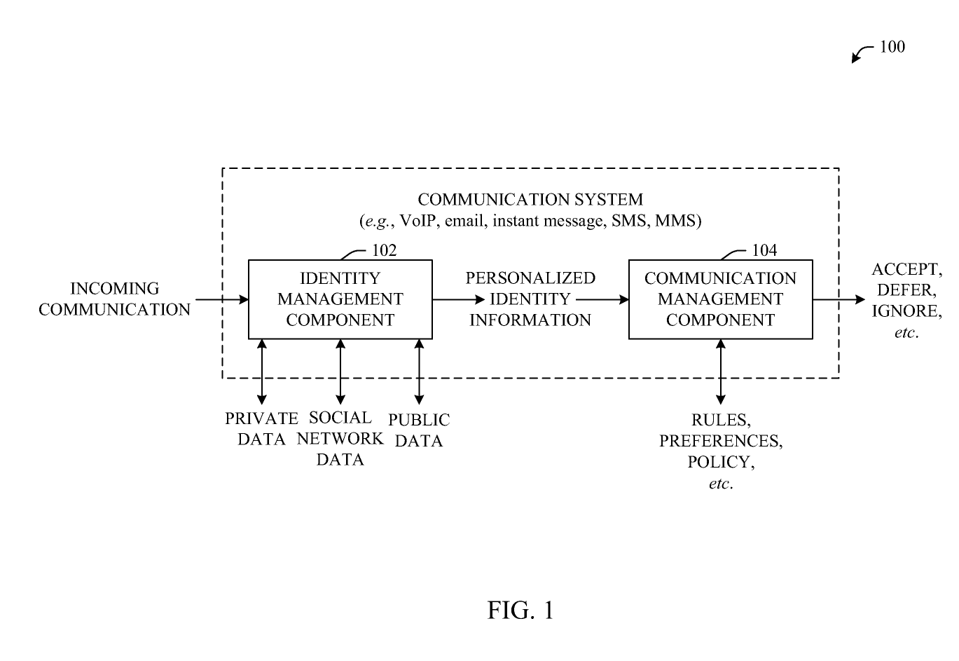

Referring initially to the drawings, FIG. 1 illustrates an example system 100 that incorporates relationship and other contextual data into communication management. Essentially, the system 100 enables the ‘who’ and ‘what’ to define the ‘how’ and ‘when’ with regard to incoming communications. In other words, who is calling and what are they calling about defines how to handle the call and when to accept a call. As will be understood, this informative system of communication management will be better described upon a review of the figures that follow.

Generally, system 100 includes an identity management component 102 and a communication management component 104 that together employ relationship (or connection) information to enable manual (or automatic) communication management. In terms of ‘who,’ ‘what,’ ‘how,’ ‘when,’ the identity management component 102 can establish the ‘who’ and ‘what’ whereas the communication management component 104 provides the ‘how’ and ‘when’ with respect to this information. In other words, by providing relationship and connection information to a receiving party, the party can make an informed decision whether to accept the communication or otherwise ignore, defer, delegate, forward, etc.

The identity management component 102 is employed to establish ‘identity’ of a party. For example, a caller can be identified which can include a user's name as well as other identifying information such as, but not limited to, role, location, context, etc. Once an identity is established, the identity management component 102 can access private, SN and public data to gather information that further defines or describes the party. In one example, the identity management component 102 can access third-party social network services to obtain information that defines relationships or connections to the caller. Features, functions and benefits of this information will become more evident upon a review of the figures that follow.

Essentially, the identity management component 102 can receive an incoming communication, analyze the communication and establish personalized identity information that describes the initiator of the communication. It is to be understood that a ‘communication’ as used herein is intended to describe most any electronic or digital communication including, but not limited to, a voice call (e.g., voice-over-Internet Protocol (VoIP)), an email, an instant message (IM), a text message (e.g., SMS (short message service)) or the like.

As illustrated in FIG. 1, the personalized identity information can be provided to a communication management component 104 which can enable a user to act upon the communication based upon the personalized identity information. For example, a user can be provided with information including, but not limited to, how they know the person, to whom they are connected, the topic of the communication, urgency of the message, etc. In other aspects, rules, policies or preferences can be employed to automate handling or management of communications on behalf of a user.

Still further machine learning and reasoning (MLR) mechanisms can be employed to automate communications management on behalf of a user. For example, inferences can be based upon the personalized identity information together with context of an intended recipient. By way of example, suppose the personalized information indicates that a caller is an employment recruiter that is a connection of three of the recipient's friends. Additionally, suppose that the recipient's context information currently indicates that they are in a meeting with their current supervisor. Here, an inference can be made to defer the call and send it directly to voice mail.

While the aforementioned example incorporates and considers context in determining management of communications, it is to be understood that the inclusion of context is but one feature of the system 100. Other aspects can infer management action based solely upon the personalized identity information in view of historical, statistical, etc. parameters. For instance, in the above example, the mere fact that the caller is an employment recruiter can automatically trigger action on behalf of a user based upon a current state of employment satisfaction.

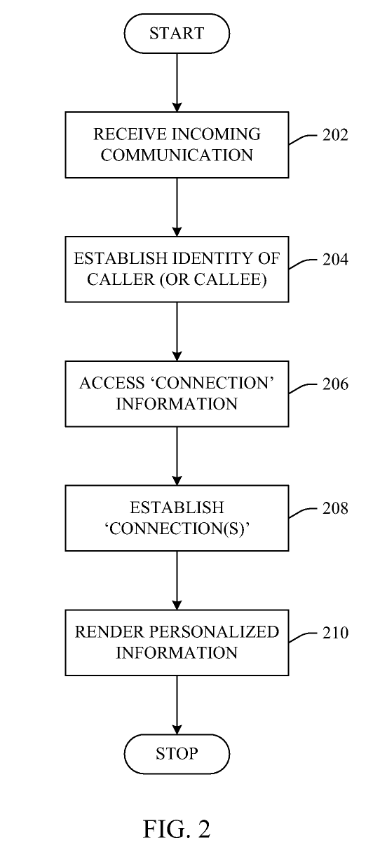

FIG. 2 illustrates a methodology of establishing and displaying personalized information in accordance with an aspect of the specification. While, for purposes of simplicity of explanation, the one or more methodologies shown herein, e.g., in the form of a flow chart, are shown and described as a series of acts, it is to be understood and appreciated that the subject specification is not limited by the order of acts, as some acts may, in accordance with the specification, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the specification.

Referring first to 202, an incoming communication is received. Here, the communication can be a voice call (e.g., VoIP), video call, or combination. Still further, in other alternative aspects, the communication can be an email, instant message, text message or other digital communication. Identity of the caller (or initiator of the communication) can be established at 204. At 204, information included within the transmitted data, e.g., metadata, header data, etc., can be used to establish this identity.

‘Connection’ information can be gathered at 206. For instance, in one aspect, a SN application or service can be used to access the connection information. Subsequently, ‘connection(s),’ or relationship(s) information can be established at 208. Once the connection(s) is established, the information can be rendered or displayed, for example by way of a VoIP phone.

As described supra, conventional caller-ID gives those receiving calls limited information (e.g., name and phone number) that allows them to decide whether to answer or defer answering, e.g., let the call go to voicemail. Unfortunately, these conventional systems are not comprehensive as the information is inconsistent and incomplete. For instance, merely providing the phone number of the caller is insufficient in many cases, but if it were augmented with information local to the person being called, it could provide more flexible and useful data. In other words, more informed decisions can be made if the information is personalized and/or comprehensive. The subject specification provides this augmentation.

As described above, SN sites and services such as, but not limited to, LinkedIn™, Plaxo™, Facebook™ and MySpace™ provide users the means to access dynamic data associated with their colleagues, co-workers, friends, etc. and to expand their visibility to potential contacts. The subject system leverages this ‘friend of a friend’ principal (or ‘degree of separation’ principal) to augment caller-ID data, so even unfamiliar callers are displayed in terms of SN linkages.

In one example, upon rendering the personalized information, the system can identify that ‘Bill Smith’ is connected to a callee through a contact ‘Scott Snyder.’ In this case, despite not knowing Bill, the callee can make some assumptions about the context of the call based on his relationship to Scott and knowledge that Scott is an employment recruiter, for instance. One assumption might be that this is not the callee's supervisor or spouse calling. Another example assumption is that it might be a call about a potential employment opportunity. Effectively, in one aspect, the subject system can combine SN linkage information with a caller's phone number to allow VoIP phone systems to provide richer caller-ID information to a callee (or caller in a ‘reverse’ scenario).

As will be understood upon a review of this specification, more real-time call context can most often result in more efficient call management decisions. Merely providing a caller's name and number (as used with conventional caller-ID systems) does not provide enough information, for example, when the caller and callee do not know each other. Additional context information gathered from SNs would allow those called to make informed communication management decisions such as, answer the call versus ‘let ring to voicemail.’ Similarly, in a ‘reverse’ scenario, the information will inform a caller as to whom they are calling and how they are connected to the callee. Thus, a caller can make an informed decision to ‘continue with the call’ or ‘hang up.’

A network effect would follow as one's SN grows, business (and other) communication(s) could become more personal. Another key benefit would be to the VoIP telephone companies that offer a service around this capability. It will be appreciated that feature differentiation is a key factor in when and how customers migrate to an IP-based phone system. Telephony customers most often want to see more integrated applications and unified communications, but it is not always safe to assume end-users will always have a PC (personal computer) running next to their phone. Integrating caller-ID and SN (or other information, e.g., PIM (personal information management) data, public data, context, mobility . . . ) information directly on hard phones can provide end-users more consistent usage benefits.

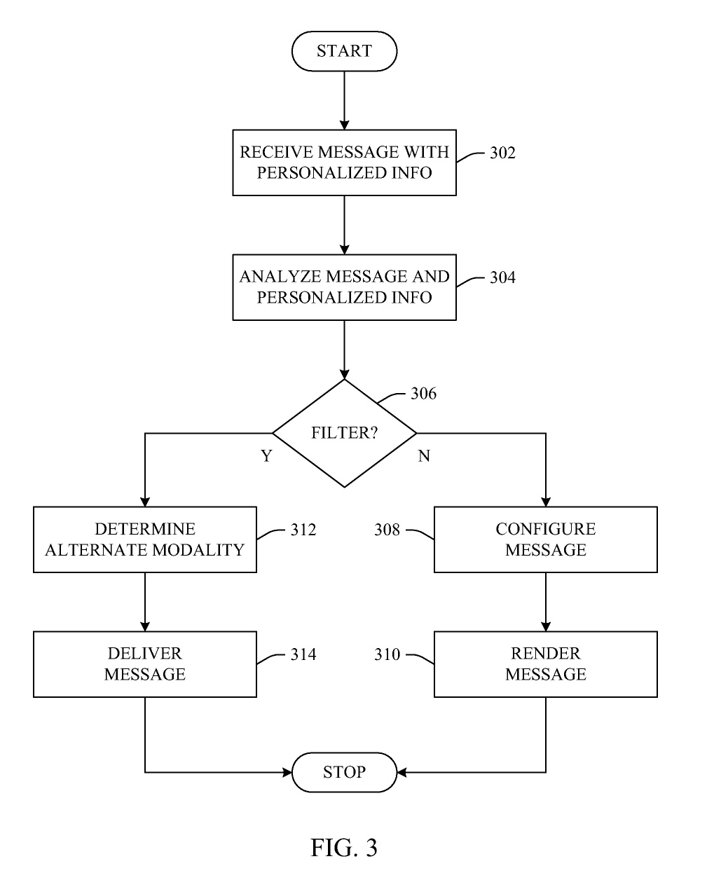

Turning now to FIG. 3, an example flow diagram of a methodology of management of communications as a function of personalized information is shown. Initially at 302, a message is received along with the personalized information. For example, as described supra, upon initially receiving the message, SN services, private data, or other public data can be searched to establish message or initiator-specific information (e.g., personalized information).

The received information can be analyzed—for example, information can be extracted from the message header (or body). As well, the gathered information can be analyzed such that a handling decision can be made at 306. In other words, at 306, it can be determined if a message should be filtered or not based upon the analysis.

If the message is not to be filtered, at 308 the message can be configured and rendered at 31 0. For instance, the message can be rendered in accordance with the original message protocol. In other words, if the message (or communication) is a VoIP call, at 310, the message can be rendered and answered by the callee.

Alternatively, if a decision is made to filter the message at 306, an appropriate modality can be determined at 312. As described above, this appropriate modality can be predetermined (e.g., rule, policy, preference) or inferred on behalf of a user. In one example, if a VoIP message is deemed to be filtered at 306, the alternate modality can be voice mail, text message, email message, etc. Thus, at 314, the voice content can be converted into an audio file and sent by way of the alternative modality as determined, desired or inferred.

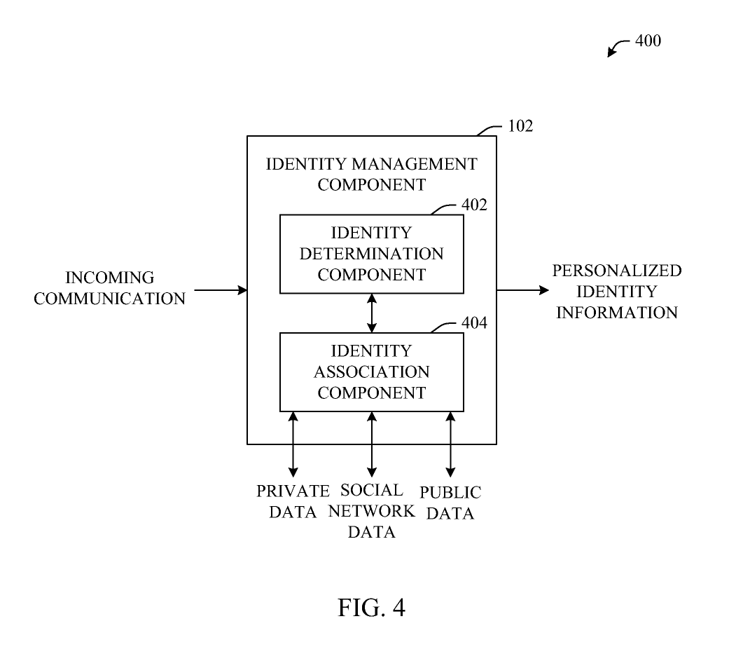

Referring now to FIG. 4, illustrated is a system 400 that can provide rich information to a user with regard to incoming communications. As described above, conventional telephony and communications systems merely provide a name and phone number of an incoming caller. The subject system 400 leverages the ability to access network-based (e.g., Internet-based) information to generate a richer and more comprehensive description of the incoming caller.

In one aspect, the system 400 can leverage existing SN databases to determine ‘connection’ or relationship to the caller. For example, this ‘connection’ information can be conveyed to a user by way of a VoIP phone display, monitor, audible announcement or the like. While many of the examples described herein are directed to VoIP communications, it is to be understood that the features, functions and benefits of the specification can be employed with most any communication modality including but, not limited to, email, instant messaging (IM), text messaging, etc.

Generally, FIG. 4 illustrates a system 400 that can extract information from an incoming communication to establish an ‘identity’ of the caller (or initiator of the communication). It is to be understood that ‘identity,’ in its simplest form can refer to the name and/or phone number of the caller. In more complex and comprehensive embodiments, the ‘identity’ can include physical location, current acting capacity (e.g., office, home, manager), engaged activity, etc. It will be appreciated that these factors can be assessed and included in association of relevant information (e.g., personalized information) which identifies the caller to a user. By way of specific example, the system can include information that defines how far away a caller is from the callee based upon real-time location information, e.g., manually inputted by a user, established via GPS (global positioning systems), etc.

As shown, system 400 can include an identity management component 102 that can evaluate incoming communications, merge ‘identity’ information with other information to deliver a personalized set of identity information to a callee. Upon receiving the personalized set of information, the callee can make an informed decision whether or not to answer the call. Further, the callee can make an informed decision as to how best to receive the communication based upon the personalized information. As well, the callee can be better prepared for the content of the call based upon this personalized set of information.

The identity management component 102 can include an identity determination component 402 and an identity association component 404. Together, these sub-components (402, 404) enable generation of the personalized identity information by establishing the identity of the caller and merging the identity information with other information available respectively. As shown, the identity management component 102 can be employed to establish the personalized identity information from private data, SN data and other public data.

In one aspect, when a call comes in it most often contains the caller's phone number and name. This information can be extracted by way of the identity determination component 402. In one example, if either or both persons (caller and callee) use (or are members of) a SN service, such as but not limited, to LinkedIn™, Facebook™, or Myspace™, then a look-up could be done by the identity association component 404 to search for matches in that SN database(s). Additionally, the identity association component 404 can derive ‘connection’ or relationship between the caller and the person being called, or callee.

These connections (called ‘friends’ in FaceBook™ and ‘connections’ in LinkedIn™) could be used by the person being called to infer the context or reason for the call. It will be understood that this ‘Friend of a Friend’ or FoaF association or service is not currently available on conventional caller-ID systems (or other electronic communication systems). It will be appreciated that, by connecting existing caller-ID and performing a look-up in the SN database, the two services could offer a new capability, for example, personalized identity information to the callee.

While many of the examples described herein are directed to providing the callee with personalized information, it is to be understood that the concepts of system 400 is capable of ‘reverse caller-ID.’ For instance, a caller can be made aware of connection to a callee by the same process as described above. It will be understood that this can be extremely useful to a caller who does not personally know the callee. In this ‘reverse’ scenario, the personalized identity information can provide a caller with information that can be used to provide ‘talking points,’ make personal associations to the callee, etc. The benefits of this information are clearly understood.

In addition to routine associations by way of a SN, a corner case issue could develop in a situation of common names like ‘John Smith.’ Upon the identity determination component 402 establishing a name and ‘from’ phone number related to a caller, a SN such as LinkedIn™ or Facebook™ could be employed to distinguish social ‘connections’ or ‘friends’ from other users with the same name via a cross-referencing mechanism. For example, the name could be cross-referenced against the area code of the caller and, if the two match, then it would give the person called added confidence that they know who the caller is despite their having a common name. While an area code is used in the aforementioned example, it is to be understood that most any criteria can be used without departing from the spirit and scope of this specification. For example, an IP address or MAC address can also be used to increase confidence of an identity.

In embodiments, a failed cross-reference could still be displayed in the event that the caller had multiple phones registered in multiple area codes. Here, confidence levels could be differentiated via a coding system on the caller-ID such as an ‘*’ asterisk, color scheme, font distinction, numerical or alphabetical ranking, etc. in the case of failed cross-references. In other words, a ‘*’ (or other desired character/mark/indicia/effect) could be placed next to (or in some other designated position) the name of the person calling if the name had been verified. Similarly, an ‘x’ (or other desired character/mark/indicia/effect) can be placed next to the name to indicate that the identity was not verified.

This personalized information can be displayed on most any device. For instance, in a particular embodiment, the information can be displayed via an IP phone such as a Cisco™ IP phone. While an implementation can employ Cisco™-brand IP phones such as the model 7960, 7961, and 7970, the ‘personalized caller-ID’ system can be employed by way of WLAN (wireless local area network) phones such as the Cisco™-brand 7920, 7921, among others. It will be understood that many of these wireless phones use the same Cisco™ Unified Communications Manager, formerly called Cisco™ Call Manager, as the wired phones. While specific hardware as well as unified communications manager systems are described herein, it is to be understood that these details are included to provide perspective to the aspects and are not intended to limit the scope of this disclosure in any manner. It is to be understood and appreciated that, while aspects are described herein that employ VoIP phones and devices (wired and wireless), the features, functions and benefits described herein can be employed in connection with most any wired or wireless device capable of transmitting and/or receiving electronic communications.

In specific examples, the concepts described herein can be employed in connection with wireless mobile devices such as cell phones, smart-phones, communication-equipped personal digital assistants (PDAs), or other communication-equipped devices. Accordingly, it is to be understood that the systems, components and methodologies described and claimed herein can be employed via these devices. These alternative aspects are to be included within the scope of the specification and claims appended hereto.

In one example, in order to display the personalized identity information, the phone would be IP-based and have ample display lines to show the personalized caller-ID information. For instance, the display would likely employ at least 3 or 4 lines as displayed in the examples below:
I. From Bill Smith* (919348734) Connected to you thru Scott Snyder
II. From Bill Smith* (919348734) Connected to you
III. From Bill Smith* (919348347) Friend of Scott Snyder John Baker and Beth Paris

These three example implementations employ from 3 to 4 lines of text on the phone display. However, it is to be understood that other aspects can be employed with as few as 1 line of display. Similarly, other aspects can employ as many as are conceivable and/or feasible upon a display. The first example shows a common connection or friend. The second reminds the callee that he/she and Bill Smith know each other directly. The third shows multiple connections between callee and the caller, Bill Smith. In alternative embodiments, scrolling features, page switching and the like can be employed to provide personalized identity information to a callee (or caller in a ‘reverse’ scenario).

As illustrated in FIG. 4, private information such as PIM data which includes contacts, calendar appointments, etc. data can be used to provide personalized caller-ID information. In one example, PIM data can be used to provide specifics such as occupation of a contact, resident location, company affiliation, past or future appointments with the caller (or callee), etc. Most any relevant information that can be associated can be included within the personalized identify information. Further, as shown, other public information can be used to associate and therefore establish personalized identity information in accordance with alternative aspects.

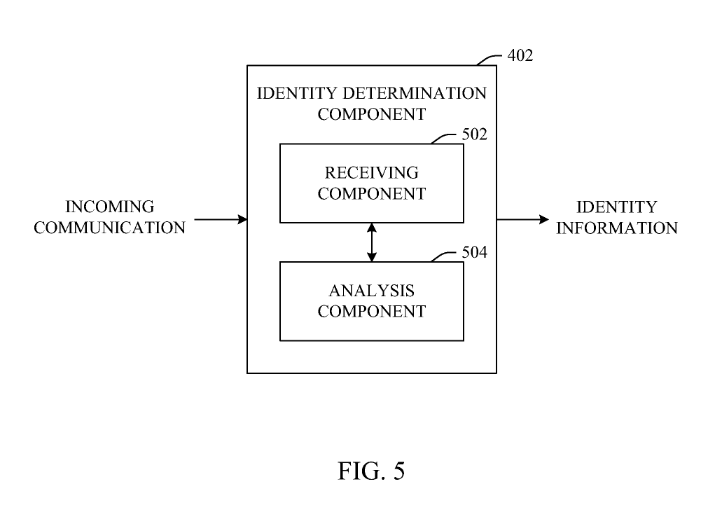

FIG. 5 illustrates a block diagram of an identity determination component 402 in accordance with an aspect of the innovation. Generally, the identity determination component 402 can include a receiving component 502 and an analysis component 504. In operation, the receiving component 502 accepts the incoming communication (e.g., VoIP call, email, IM . . . ).

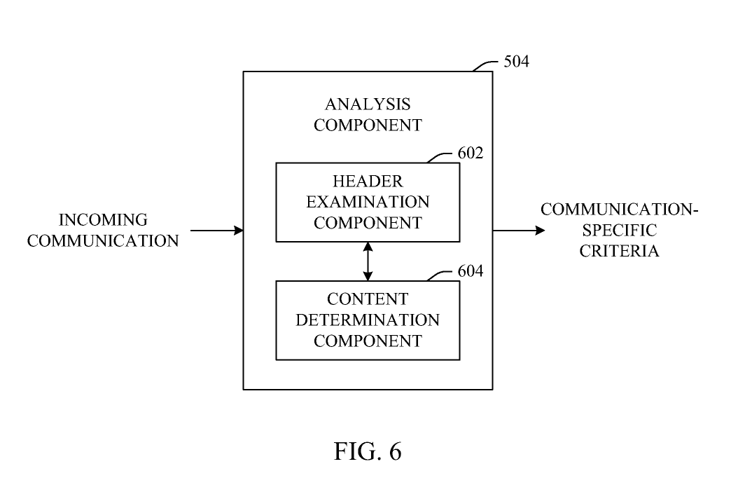

Once a communication is received, that analysis component 504 can evaluate the received communication to thereafter establish identity of the initiator (e.g., sender, caller). In one example, packet header information can be examined to determine the identity of the sender. For instance, the header information can identify the phone number, email address, etc. of the sender or initiator. Additionally, it is to be understood that the analysis is capable of establishing multiple points of identification from the communication. An example analysis component 504 is illustrated in FIG. 6 that follows.

In FIG. 6, the example analysis component 504 is illustrated including a header examination component 602 and a content determination component 604. Essentially, these two sub-components can define communication-specific criteria from the incoming communication. As will be described below, this communication-specific criterion can be used to establish other relevant information (e.g., connections or relationships) that assists a user in managing communications.

The header examination component 602 can be used to extract identification information from a header or first part of a message. In many cases, this header information contains controlling data, such as originating and/or destination stations, message type and priority level. As will be understood, this embedded information can be used to easily discern, determine or infer an identity of the originator, sender or caller.

In one specific VoIP example, a SIP (Session Initiation Protocol) header can be loaded with information which identifies the initiator or sender. As will be understood, SIP is a known protocol commonly used in IP telephony services. As SIP is somewhat less complex and uses less resources than its counterparts, it is commonly used in mobile devices. While SIP is specifically described above, it is to be understood that SIP is but one example of a protocol in accordance with the innovation. In other words, it is to be understood that other protocols can be employed without departing from the spirit and/or scope of the innovation and claims appended hereto.

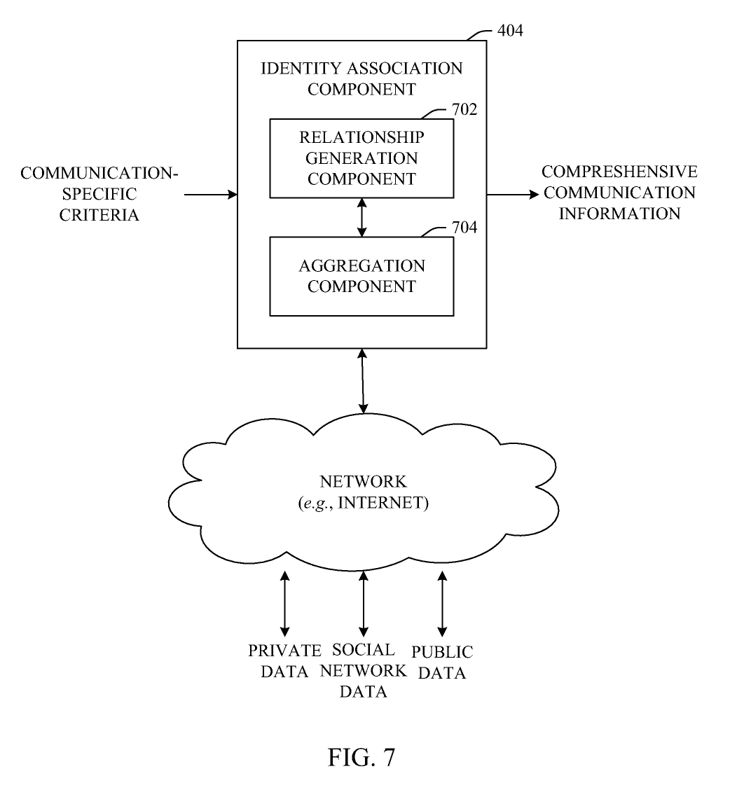

The content determination component 604 provides yet another mechanism to establish communication-specific criteria from an incoming communication. For example, in VoIP communication, speech recognition mechanisms can be employed to establish content of the communication. Here, a user (or caller) can be prompted to state the subject of the call upon establishing communication. As such, the analysis component 504 can employ speech recognition to automatically convert the subject to text. Similarly, in the case of text communication, keywords and frequency of words can be employed to establish content of a communication. Once the communication-specific criteria is established, it can be provided to the identity association component 404 as shown in FIG. 7.

Referring now to FIG. 7, a block diagram of an example identity association component 404 is shown. Generally, identity association component 404 employs a relationship generation component 702 and an aggregation component 704 to establish relationship and/or connection information between the initiator and recipient (or caller and callee in a VoIP example).

Effectively, the relationship generation component 702 can access private data, SN data or other public data to establish links between the parties of the communication. While many of the examples describe two party communications, it is to be understood that other examples employ more than two parties without departing from the scope of the specification. In these examples, the relationship generation component 702 is capable of establishing relationships between the parties as well as cross-relationships among the parties.

The relationship generation component 702 can effect communication (wired or wireless) to private information (e.g., PIM data), SN data or other public data in order to establish background information and connection information. As described above, the relationship generation component 702 can use local, external as well as third-party data (e.g., SN services) to identify relationships between the parties. This information can be consolidated or compiled by way of the aggregation component 704. As relationships are established, they can be aggregated such that the comprehensive communication information links the parties of the communication.

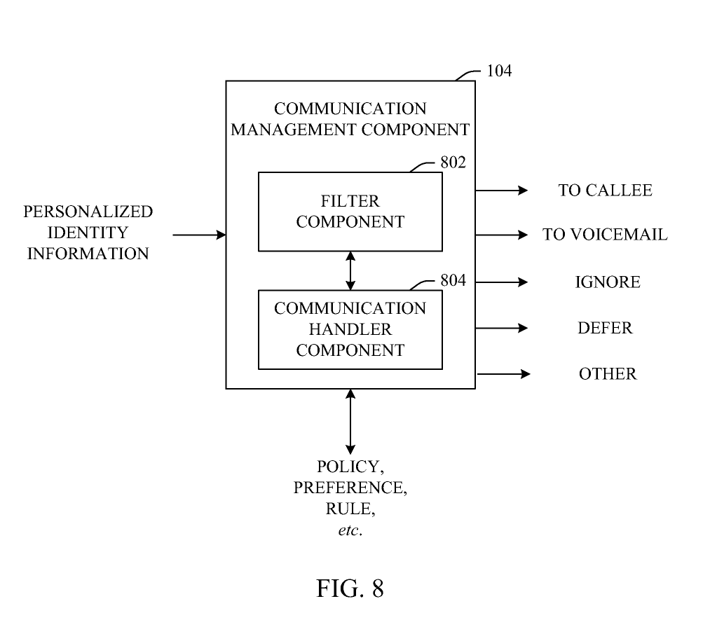

FIG. 8 illustrates a block diagram of an example communication management component 104 in accordance with an aspect of the disclosure. As described above, the specification describes mechanisms by which comprehensive message/communication management can be accomplished as a function of the personalized identity information. As shown, the communication management component 104 can include a filter component 802 and a communication handler component 804. Together, these sub-components (802, 804) can enable automatic or manual direction or handling of communications based upon a policy, preference, rule or the like.

The filter component 802 can be employed to enforce policies, preferences and rules related to incoming communications. For example, as communications are received and personalized identity information (e.g., identity, connections, relationships) is established, the filter component 802 can access predetermined or pre-defined rules which facilitate appropriate or desired management or handling of the communication. In other aspects, the filter component 802 can use the personalized identity information to infer an action on behalf of the user with respect to communication management.

As shown, the filter component 802 works in conjunction with a communication handler component 804 to direct the message appropriately. As shown, examples of direction can include, but are not limited to, directing the message to the callee (e.g., to answer the call), redirecting the message to voicemail, ignoring the communication, deferring the communication to another person on the callee's behalf, redirecting the communication to another location or modality (e.g., email, IM, text message . . . ).

Essentially, the specification describes mechanisms by which digital communications can be handled or managed more comprehensively and thus, more effectively. The personalized identity information established from a communication by way of private data, SN data or other public data enables a user to make more informed decisions with regard to incoming communications. Additionally, as shown in FIG. 8, a communication management component 104 can use this personalized identity information to act on behalf of a user either by way of a rule, preference, policy or inference.

In aspects, the specification describes mechanisms that converge caller-ID services with information available by way of SN services. This convergence prompts users to more intelligently manage communications thereby, enhancing time management as well. Essentially, the specification describes aspects that connect existing communication systems (e.g., telephone networks) with commercially available third-party messaging systems as well as SN services.

Still other alternative aspects can employ machine learning and reasoning (MLR) mechanisms which facilitate automating one or more features in accordance with the subject specification The subject specification (e.g., in connection with establishing identity or ‘connection’, invoking communication handling rules) can employ various MLR-based schemes for carrying out various aspects thereof. For example, a process for determining common name differentiation can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject specification can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria an identity of a caller (or callee), affiliation to other users, connections to individuals, communication handling procedures and actions, etc. It will be understood that most any decision logic effected by the subject system can employ MLR mechanisms.

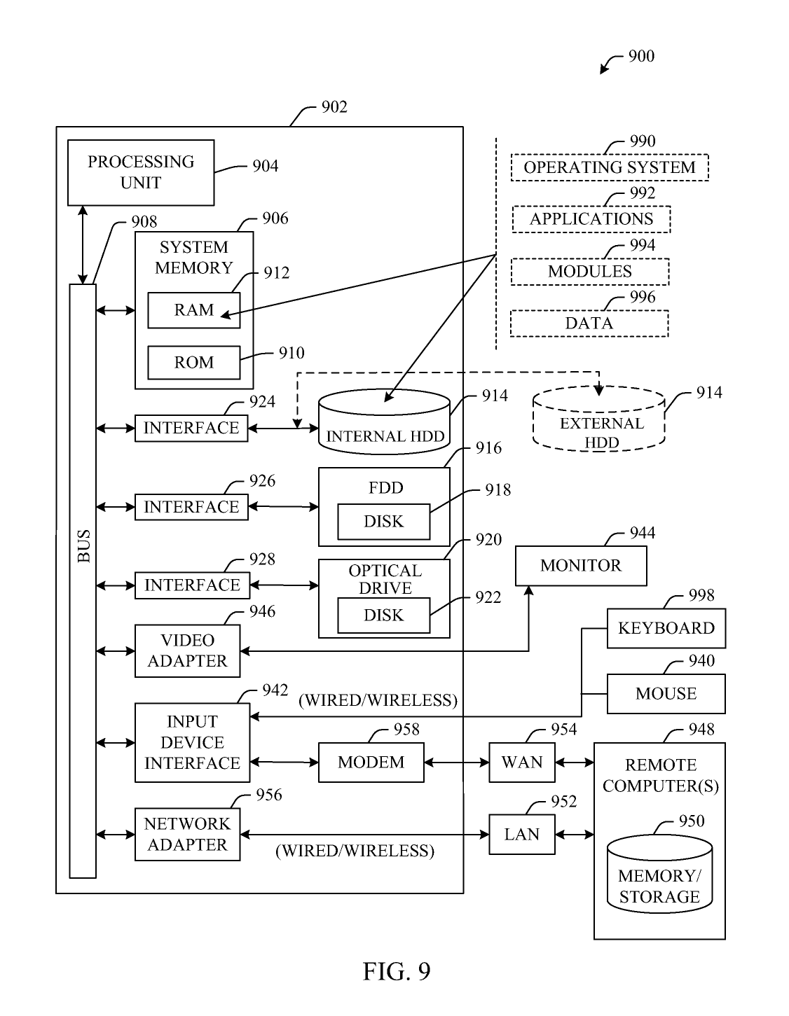

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

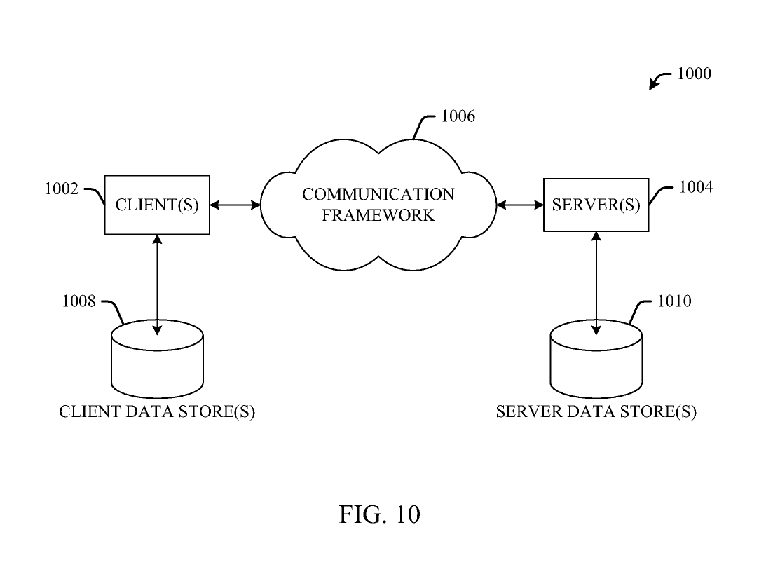

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the specification. It is, of course, not possible to describe every conceivable combination of components or methodologies for purposes of describing the subject specification, but one of ordinary skill in the art may recognize that many further combinations and permutations of the specification are possible. Accordingly, the specification is intended to embrace all such alterations, modifications and variations that fall within the spirit and scope of the appended claims. Furthermore, to the extent that the term ‘includes’ is used in either the detailed description or the claims, such term is intended to be inclusive in a manner similar to the term ‘comprising’ as ‘comprising’ is interpreted when employed as a transitional word in a claim.

What is claimed is:

1. A system, comprising:
an identity determination component that establishes ‘identity’ of a first party to a communication; and
an identity association component that establishes relationship data based at least in part upon the ‘identity’ of the party and renders at least a subset of the relationship data to a second party of the communication.

2. The system of claim 1, wherein the identity association component renders the connection data by way of an IP-based (Internet Protocol) phone.

3. The system of claim 2, wherein the IP-based phone includes a display capable of at least three lines of text on a display.

4. The system of claim 1, the first party is a caller, the second party is a callee and the communication is a Voice-over-Internet Protocol (VoIP) call.

5. The system of claim 1, the identity association component employs a social network (SN) service to establish the relationship data.

6. The system of claim 1, the identity association component employs at least one of PIM (personal information manager) data or public-accessible network data to establish the relationship data.

7. The system of claim 1, further comprising a machine learning and reasoning (MLR) component that employs at least one of a probabilistic and a statistical-based analysis that infers an action that a user desires to be automatically performed.

8. The system of claim 1, further comprising:
a receiving component that receives the communication, wherein the communication is a digital communication; and
an analysis component that analyzes one of header or body of the communication to establish communication-specific criteria, wherein the communication-specific criteria facilitates establishment of the relationship data.

9. The system of claim 1, further comprising:
a relationship generation component that employs at least one of private data, SN data or public data to establish a plurality of relationships to individuals; and
an aggregation component that compiles the plurality of relationships to establish the relationship data.

10. The system of claim 1, further comprising a communication management component that employs the relationship data to automatically manage the communication.

11. A computer-implemented method of providing comprehensive identity information via a voice-over-Internet Protocol (VoIP) phone, comprising:
establishing identity of a first party to a VoIP communication, wherein identity includes at least a name of the first party;
accessing association information that employs the identity to define a link between the first party and a second party of the VoIP communication;
establishing the link based at least in part upon the association information; and
rendering a subset of the association information to the second party.

12. The computer-implemented method of claim 11, further comprising connecting to a social network (SN) service, wherein the SN provides at least a subset of the connection information.

13. The computer-implemented method of claim 11, further comprising analyzing header information of the VoIP communication, wherein a subset of the header information includes data associated with the identity.

14. The computer-implemented method of claim 11, further comprising filtering the VoIP communication based upon a subset of the association information.

15. The computer-implemented method of claim 14, further comprising determining an alternate modality for delivery of content of the VoIP communication.

16. A system that facilitates communication management, comprising:
means for establishing an identity of an initiator of a communication;
means for generating association data based upon the identity, wherein the association data defines a link between the initiator and a target of the communication;
means for displaying at least a subset of the association data to the target, wherein the target employs the subset of the association data to comprehensively manage the communication.

17. The system of claim 16, further comprising means for automatically handling the communication based upon one of a rule, preference or inference.

18. The system of claim 16, wherein the communication is one of a voice-over-Internet Protocol (VoIP) call, an email, an instant message or a text message.

19. The system of claim 16, further comprising means for accessing a third-party social network (SN) service, wherein the SN service facilitates establishment of the link between the initiator and the target.

20. The system of claim 16, wherein the means for displaying is a VoIP phone.
